(19) United States
(12) Patent Application Publication
(10) Pub. No.: US 2019/0280456 A1
(43) Pub. Date: Sep. 12, 2019

(54) CASCADED, LONG PULSE AND CONTINUOUS WAVE RAMAN LASERS

(71) Applicant: Macquarie University, North Ryde (AU)

(72) Inventors: Robert Williams, Glenorie (AU); Richard Paul Mildren, Abbotsford (AU); David James Spence, Forestville (AU); Oliver Lux, Gilching (DE)

(73) Assignee: Macquarie University, North Ryde (AU)

(21) Appl. No.: 16/334,939

(22) PCT Filed: Sep. 21, 2017
(86) PCT No.: PCT/AU2017/051029

§ 371 Date: Mar. 20, 2019

(30) Foreign Application Priority Data
Sep. 22, 2016 (AU) 2016903830
Jun. 26, 2017 (AU) 2017902466

(51) Int. Cl. H01S 3/30; H01S 3/08; H01S 3/0941; H01S 3/16

(52) U.S. Cl. CPC H01S 3/30; H01S 3/163; H01S 3/09415; H01S 3/08059

(57) ABSTRACT

A Raman Laser device having an nth Stokes shifted output the device including: a laser pump input; a lasing cavity having feedback elements at each end; and a diamond Raman active gain medium within the cavity, exhibiting first and higher Stokes emissions when subjected to pumping by the laser pump input; wherein the feedback elements feeding back the pump input, and 1st Stokes output from the gain medium, and a gain portion of the higher Stokes outputs, with a transmitting portion of the nth Stokes output being the output of the device.

### FIELD OF THE INVENTION

The present invention provides systems and methods for diversifying the wavelength range of high power lasers. The present invention also provides for systems and methods for providing high output power lasing using Raman frequency conversion.

### REFERENCES

[1] V. R. Supradeepa and J. W. Nicholson, Optics Letters 38(14), 2538-2541 (2013).
[2] Y. Jeong, S. Yoo, C. A. Codemard, J. Nilsson, J. K. Sahu, D. N. Payne, R. Horley, P. W. Turner, L. Hickey, A. Harker, M. Lovelady, and A. Piper, IEEE Journal of Selected Topics in Quantum Electronics 13(3), 573-579 (2007).
[3] M. A. Jebali, J. N. Maran, and S. LaRochelle, Optics Letters 39(13), 3974-3977 (2014).
[4] A. Sabella, J. A. Piper, and R. P. Mildren, Optics Letters 39(13), 4037-4040 (2014).
[5] E. Granados, D. J. Spence, and R. P. Mildren, Optics Express 19(11), 10857-10863 (2011).
[6] M. Jel'inek, O. Kitzler, H. Jel'inkova', J. S\check{ }ulc, and M. Ne\check{ }mec, Laser Physics Letters 9(1), 35-38 (2012).
[7] O. Kitzler, A. McKay, and R. P. Mildren, Optics Letters 37(14), 2790-2792 (2012).
[8] M. Murtagh, J. Lin, R. P. Mildren, and D. J. Spence, Optics Letters 39(10), 2975-2978 (2014).
[9] P. J. Schlosser, D. C. Parrotta, V. G. Savitski, A. J. Kemp, and J. E. Hastie, Optics Express 23(7), 8454-8461 (2015).
[10] R. J. Williams, J. Nold, M. Strecker, O. Kitzler, A. McKay, T. Schreiber, and R. P. Mildren, Laser & Photonics Reviews 9(4), 405-411 (2015).
[11] O. Kitzler, A. McKay, D. J. Spence, and R. P. Mildren, Optics Express 23(7), 8590-8602 (2015).
[12] A. Sabella, J. A. Piper, and R. P. Mildren, Optics Express 19(23), 23554-23560 (2011).
[13] A. McKay, O. Kitzler, and R. P. Mildren, Laser & Photonics Reviews 8(3), L37-L41 (2014).
[14] R. J. Williams, O. Kitzler, A. McKay, and R. P. Mildren, Optics Letters 39(14), 4152-4155 (2014).

### BACKGROUND OF THE INVENTION

Any discussion of the background art throughout the specification should in no way be considered as an admission that such art is widely known or forms part of common general knowledge in the field.

High-brightness continuous-wave (CW) beams in the 1.5-1.6 μm wavelength range and beyond are of great interest for defence, security, industry and sensing applications requiring beam propagation over long distances, due to the combination of atmospheric transparency and relative “eye-safety” from scattered radiation. Despite this, power scaling of Er-doped fiber lasers has not been nearly as successful as with their Yb- and Tm-doped counterparts.

Yb-doped fiber lasers have reached the 10 kW power level around 1.1 μm in a diffraction-limited beam, and Tm-doped fiber lasers have exceeded 1 kW at 2.0 μm. By comparison, CW diffraction limited beam powers around 1.5 μm have not exceeded 301 W for single-transverse-mode fiber lasers [1]. Er,Yb co-doped fibers are hindered by the onset of ytterbium parasitic lasing, limiting efficiency [2]. Diodes at 1.48 μm for in-band pumping of erbium at 1.48 μm remain costly. As an alternative to direct diode pumping, Jebali et al. employed a combination of thirty-six Er,Yb co-doped fiber lasers to achieve in-band pumping of erbium and reached 264 W output [3].

Raman fiber lasers and amplifiers have enabled high-power conversion from 1.12 to 1.48 μm in five Stokes shifts [1]; however spectral broadening from Raman gain in glass fibers leads to linewidths greater than 10 nm, hindering further cascading into the atmospheric transparency window. Hence, novel source technologies are needed to meet the demands for high-brightness CW beams around 1.5 μm and beyond.

### SUMMARY OF THE INVENTION

It is an object of the invention, in its preferred form to provide a method and system for providing high output power lasing using Raman frequency conversion.

In accordance with a first aspect of the present invention, there is provided a Raman Laser device having a 2nd Stokes shifted output, the device including: a laser pump input; a lasing cavity having feedback elements at each end; a diamond Raman active gain medium within the cavity, exhibiting first and second Stokes emissions when subjected to pumping by the laser pump input; wherein the feedback elements feeding back the pump input, and 1st Stokes output from the gain medium, and gain and transmit a portion of the second Stokes output as the 2nd Stokes output of the device.

The feedback elements can comprise mirrors with high reflectivity at the pump and first Stokes wavelength, with the output mirror having a lower reflectivity at the second Stokes wavelength.

In some embodiments, the mirror reflectivity at the pump and first Stokes wavelength exceeds 98%. In some embodiments, the output mirror has a reflectivity at the second Stokes wavelength of less than about 50%. In some embodiments, the output mirror has a reflectivity at the second Stokes wavelength of less than about 12%.

The laser pump can provide a continuous wave input and the 2nd Stokes output can be a continuous wave output. The pump wavelength can be approximately in the 1.06-1.1 μm range. The diamond can comprise a low birefringence, low nitrogen diamond material. The pump laser can comprise a Nd:Yag laser.

In some embodiments, the laser pump input is tuneable, producing a tuneable 2nd Stokes shifted output. The laser pump can include a tuneable DFB laser producing a first output which is amplified by a second laser amplifier to produce said laser pump input. The device can also include an optical isolator connected between the laser pump input and the lasing cavity. In some examples, the device includes a volume Bragg grating (VBG) secondary cavity mirror, providing feedback at the second Stokes output. The VBG can be temperature stabilised.

In accordance with a further aspect of the invention, there is provided a Raman Laser device having an nth Stokes shifted output the device including: a laser pump input; lasing cavity having feedback elements at each end; and a diamond Raman active gain medium within the cavity, exhibiting first and second Stokes emissions when subjected to pumping by the laser pump input; wherein the feedback elements feeding back the pump input, and 1st Stokes output from the gain medium, and a gain portion of the higher Stokes output, with a transmitting portion of the nth Stokes output being the output of the device.

In accordance with a further aspect of the present invention there is provided a Raman Laser device having an nth Stokes shifted output the device including: a laser pump input; a lasing cavity having feedback (that is, resonant at particular Stokes wavelengths) elements at each end; and a diamond Raman active gain medium within the cavity, exhibiting multiple cascaded Stokes emissions when subjected to pumping by the laser pump input; wherein the feedback elements provide strong feedback at the all Stokes orders up to the chosen nth Stokes output order, and feedback at the nth Stokes output from the gain medium, and are structured to suppress feedback of the (n+1) Stokes emission. In some embodiments, n is odd and the (n+1) Stokes emission is even. Optimized output coupling values for odd and even nth orders, and the optimum required loss values for the (n+1)th are surprisingly found to be quite different.

In accordance with a further aspect of the present invention there is provided Raman laser system for lasing in substantially greater than about the 2 μm region, said system including: a diamond core lasing medium; a cascaded Stokes generation system surrounding said core and generating in said core, a first and second stokes output; said cascaded Stokes generation system including: a first Stokes generation system generating a Stokes output below about 2 μm in the diamond core lasing medium; and a first Stokes pumping system pumping the diamond core lasing medium in conjunction with the first Stokes output to generate a second Stokes output in the range of greater than about 2 microns.

### BRIEF DESCRIPTION OF THE DRAWINGS

Embodiments of the invention will now be described, by way of example only, with reference to the accompanying drawings in which:

FIG. 1 is a schematic diagram of an embodiment of a device suitable for use with the present invention.

FIG. 2 is a graph illustrating the slope efficiency curve for the 2^{nd} Stokes output power relative to input pump power, with the inset showing the beam profile.

FIG. 3 is a graph illustrating the slope efficiency curve for the 2^{nd} Stokes output power relative to input pump power, for a high reflectivity second Stokes mirror.

FIG. 4 is a side perspective of a proposed prototype laser formed in accordance with an embodiment.

FIG. 5 illustrates schematically an alternative example of a tuneable second Stokes Raman laser.

FIG. 6 shows the performance of the second Stokes diamond Raman laser, with output power of the first and second Stokes radiation as well as residual pump power versus pump power.

FIG. 7 shows the Raman laser spectrum dependence on the temperature of the DFB pump laser diode.

FIG. 8 illustrates an experimental setup of the VBG-stabilized second Stokes Raman laser.

FIG. 9 illustrates the spectral properties of the second Stokes diamond Raman laser: (a) Stokes output spectrum with and without optical feedback from the volume Bragg grating (VBG).

FIG. 10 illustrates temporal fluctuations of the centre wavelength measured at 500 mW Stokes power.

FIG. 11 illustrates mode hopping of the second Stokes diamond Raman laser.

FIG. 12 is a diagram showing the effective mode spacing in a second Stokes Raman laser is twice the cavity mode spacing.

FIG. 13 is a graph of the model of external-cavity diamond Raman lasers for output coupling at either the 1st, 2nd, 3rd, 4th or 5th Stokes shift under 1.06 μm pumping with 300 W pump power focussed to a spot of 30 μm radius in the diamond, neglecting multi-phonon absorption in diamond at the 4th and 5th Stokes shifts (2.5 μm and 3.7 μm).

FIG. 14 is a graph of the model of external-cavity diamond Raman lasers for output coupling at either the 1st, 2nd, 3rd, 4th or 5th Stokes shift under 0.53 μm pumping with 50 W pump power focussed to a spot of 15 μm radius in the diamond.

FIG. 15 and FIG. 16, plots the minimum tolerable loss at the (n+1)th Stokes order for a nth Stokes laser, in order to avoid cascading to the (n+1)th Stokes order (which clamps the nth Stokes output for increased pump power).

FIG. 17 illustrates the absorption coefficient of Diamond with wave number.

### DETAILED DESCRIPTION

The preferred embodiments provide for a system and method which provides for efficient, high-power frequency conversion to a variety of hard-to-reach wavelengths in CW, nanosecond, and femtosecond pulse regimes.

Raman conversion in diamond is an emerging technology capable of providing frequency conversion to a variety of hard-to-reach wavelengths in CW, nanosecond, and femtosecond pulse regimes [4-9].

Diamond's exceptional thermal properties differentiate it from conventional Raman crystals, and have enabled CW power levels to reach 380 W without significant detrimental thermal effects [10]. Also, the material properties of diamond have enabled CW conversion at high powers in an external cavity configuration [7], a design suitable for conversion of existing high-power pump sources such as fiber lasers. Diamond Raman conversion in the external cavity CW regime has been demonstrated on the 1st Stokes shift (from 1.06 μm to 1.24 μm), and recent modelling has elucidated the effects of design parameters on device performance [11].

Cascading to the 2nd Stokes shift in an external cavity, for conversion to eye-safe wavelengths, has been demonstrated with nanosecond-pulse pumping [12, 13] and modelled using numerical methods [12], where the high peak pump intensities typically provide very high gain.

However, efficient cascaded Stokes shifting in the CW external-cavity regime, where pump intensities and round-trip Stokes gain is thought to be very low, has not been demonstrated.

The first embodiment provides for a CW, cascaded-Stokes crystalline Raman oscillator using an external cavity, which allows for direct conversion of ytterbium fiber lasers emitting at 1.06-1.1 μm to the 1.5 μm spectral range.

The exceptional thermal properties of diamond enables efficient conversion at high output powers while maintaining diffraction-limited beam quality, and the large Raman shift of diamond (1332 cm⁻¹) facilitates conversion from 1.1 to 1.5 μm in two Stokes shifts.

Without wishing to be bound by theory, the analysis examines an analytical model of the 2nd-Stokes external cavity Raman oscillator, revealing a high-gain regime for the 2nd Stokes as the route to efficient conversion. Efficient conversion is demonstrated in this regime achieving more than 100 W output and 55% slope efficiency. For verification of the model, experimental results involving the use of second Stokes feedback that was strong (high-Q) and weak (low-Q) was obtained. These results showed that efficient operation is obtained with weak feedback, whereas efficiency decreased when using strong feedback due to suppression of conversion from the pump. The demonstrated trend of efficiency in the high-gain regime, combined with 1st-Stokes diamond laser results, as disclosed in US Patent Publication 2015/0085348 and [10], can be utilized for power-scaling possibilities for this technology well-beyond 300 W.

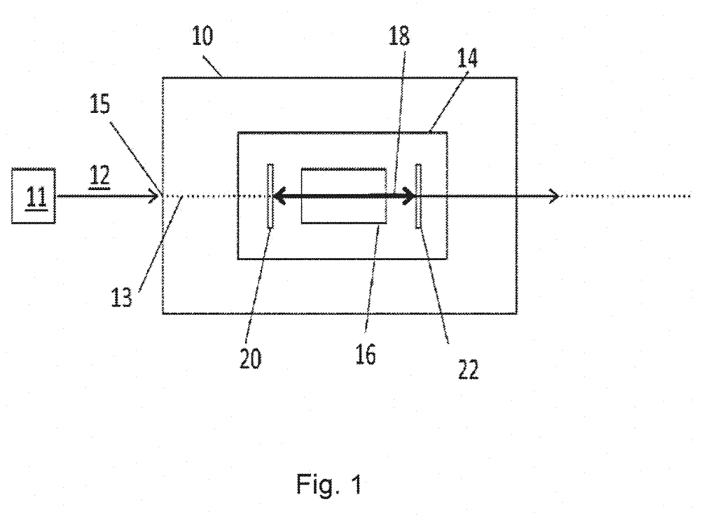

FIG. 1 shows an embodiment of a laser as disclosed in the aforementioned US Patent Publication 2015/0085348. The device is provided for converting light 12 received thereby, the device being generally indicated by the numeral 10. The light 12 is generated by a light source 11 in the form of a continuous wave rare earth ion doped laser, specifically a laser having a neodymium doped yttrium aluminium garnet crystal, although any suitable light source may be used. In another embodiment, the laser has a neodymium doped vanadate crystal. The device 10 and the light source 11 are cooperatively arranged for the device to receive the light 12. That is, in this but not necessarily in all embodiments, the beam output of the light source 11 is aligned with an optical axis 13 at an input optical port 15 of the device.

The arrangement of FIG. 1 was utilised to provide a high level of 2^{nd} Stokes beam power. To allow a simple analytical model based on a practical laser design for external-cavity CW conversion, the following assumptions are made. A top-hat beam profile of fixed radius throughout the crystal and of equal radius for the pump, 1st and 2nd Stokes beam. The assumption of fixed radius through the crystal is acceptable in this case, in which the crystal length is similar to the confocal parameter of the pump and Stokes beams.

The assumption of equal radii for each beam overestimates the effective gain, but is tolerable for the case of tightly focussed pump and Stokes beams which are required for achieving moderate thresholds in CW operation. In this model we include a double-pass of the pump through the diamond, and since a linear cavity is used, the Stokes field makes two passes through the crystal per round trip. The depletion of the pump field and the gain for the 2nd Stokes field are both functions of the 1st Stokes intra-cavity intensity and can be written as:

$$\begin{matrix}\frac{{dI}_{p} ( z )}{dz} = {I}_{p} ( z ) \frac{- g}{{η}_{1}} ( {I}_{1 S} ( z ) + {I}_{1 S} ( 2 L - z ) ) , and & ( 1 ) \\ \frac{{dI}_{2 S} ( z )}{dz} = {I}_{2 S} ( z ) ( {η}_{2} g ( {I}_{1 S} ( z ) + {I}_{1 S} ( 2 L - z ) ) - α ) , & ( 2 )\end{matrix}$$

where Iₚ, I_{1S}, and I₂₅ are the pump, 1st Stokes and 2nd Stokes intra-cavity intensities, respectively; z is the beam propagation axis; L is the length of the diamond; a is the distributed loss coefficient for the 2nd Stokes field (accounting for absorption and scattering in the Raman crystal); g is the Raman gain coefficient for the 1st Stokes field; η₁=λₚ/λ_{1S} is the quantum defect for the 1st Stokes shift (λₚ, λ_{1S} are the pump and 1st Stokes wavelengths, respectively); and similarly η₂=λ_{1S}/λ_{2S}. The depletion for the pump is proportional to g/η₁ due to the energy lost to a phonon for each scattered 1st Stokes photon, and the gain for the 2nd Stokes is proportional to η₂g to account for the reduced Raman gain at longer wavelengths.

I_{1S}(z)+I_{1S}(2L−z) the sum of the forward and backward-propagating 1st Stokes intensities at z in the diamond. Since, for a practical 2nd Stokes laser, the cavity output-coupling at the 1st Stokes will be as close to zero as possible, and thus there are no significant discrete losses in the cavity for the 1st Stokes, it is assumed that the 1st Stokes intensity is invariant in z in the steady state. Thus I_{1S}(z)+I_{1S}(2L−z)=2I_{1S} and Eq. (1) and (2) can integrated over one round-trip to give:

$$\begin{matrix}{I}_{p} ( 2 L ) = {I}_{p} ( 0 ) exp [ \frac{- 4 {gLI}_{1 S}}{{η}_{1}} ] , and & ( 3 ) \\ {I}_{2 S} ( 2 L ) = {I}_{2 S} ( 0 ) exp [ 4 {η}_{2} {gLI}_{1 S} - 2 α L ] . & ( 4 )\end{matrix}$$

For a laser in steady-state one can substitute the reflectivity of the 2nd Stokes output coupler R₂₅=I₂₅(0)/I₂₅(2_{L}), giving

$$exp [ 4 {η}_{2} {gLI}_{1 S} - 2 α L ] = \frac{1}{{R}_{2 S}} \\ 4 {η}_{2} {gLI}_{1 S} = - ln {R}_{2 S} + 2 α L \\ ∴ {I}_{1 S} = \frac{- ln {R}_{2 S} + 2 α L}{4 {η}_{2} gL} . \qquad ( 5 )$$

Thus, for increasing pump power above the 2nd Stokes threshold, the intra-cavity 1st Stokes intensity is clamped to a fixed level, and Eq. (5) is simply the threshold condition for a 2nd Stokes laser. Substituting this expression for I_{1S} into Eq. (3), provides:

$$\begin{matrix}{I}_{p} ( 2 L ) = {I}_{p} ( 0 ) exp [ \frac{ln {R}_{2 S} - 2 α L}{{η}_{1} {η}_{2}} ] \\ = {I}_{p} ( 0 ) {R}_{2 S}^{\frac{1}{{η}_{1} {η}_{2}}} {e}^{\frac{- 2 α L}{{η}_{1} {η}_{2}}} .\end{matrix} \qquad ( 6 )$$

The residual pump power above threshold for 2nd Stokes oscillation is proportional to the injected pump power, and the constant of proportionality is close to the reflectivity of the output coupler (in a typical laser where parasitic losses are small). Therefore, for low 2nd Stokes output coupling (R_{2S} close to 1), the diamond cavity is almost transparent for the pump, and conversion from the pump to the 1st and 2nd Stokes is suppressed. Whereas for high 2nd Stokes output coupling, pump depletion and conversion to the 2nd Stokes can be high.

Since the 1st Stokes intra-cavity field is clamped in a 2nd Stokes laser, it follows by energy conservation that the depleted fraction of pump light injected beyond the threshold for 2nd Stokes lasing is converted to the 2nd Stokes. Thus the out-coupled 2nd Stokes intensity:

$$\begin{matrix}{I}_{2 S \text{-} out} = ( ( {I}_{p} ( 0 ) - {I}_{pTh} ( 0 ) ) - ( {I}_{p} ( 2 L ) - {I}_{pTh} ( 2 L ) ) ) {η}_{1} {η}_{2} \\ = η {η}_{2} ( {I}_{p} ( 0 ) - {I}_{pTh} ( 0 ) ) ( 1 - {R}_{2 S}^{\frac{1}{{η}_{1} {η}_{2}}} {e}^{\frac{- 2 α L}{{η}_{1} {η}_{2}}} ) ,\end{matrix} \qquad ( 7 )$$

where I_{pTh}(z) is the intra-cavity pump intensity at the threshold for 2nd Stokes generation. Table 1 provides calculated values for the slope efficiency and the slope of the residual pump for a set of values of R₂₅, for a 2nd Stokes diamond laser pumped at 1.06 μm (λ_{2S}=1.49 μm, quantum-limited efficiency η₁ η₂=72%).

It should be noted that the clamping of the first Stokes output may be useful for developing Raman lasers with low amplitude noise and that is insensitive to pump laser intensity fluctuations.

TABLE 1
Model values for 2nd Stokes slope efficiency and residual
pump for 1064 nm pumping in diamond

| R_{2S} (%) | Slope efficiency | Residual pump |
|---|---|---|
| 10 | 69 | 4 |
| 50 | 45 | 38 |
| 95 | 5 | 92 |

The diamond Raman laser cavity design is similar to our previous work [7, 10, 14] except in this case the mirrors are designed to take advantage of 2nd Stokes operation. The input coupler mirror was formed to be substantially transparent for the pump (1.06 μm) and highly reflecting at the 1st and 2nd Stokes wavelengths (1.24 μm and 1.49 μm, respectively), and had a radius of curvature of 100 mm. The diamond used was an 8×4×2 mm low-birefringence, low-nitrogen, single-crystal diamond (ElementSix Ltd., UK). In order to demonstrate the new trends revealed by the model, three different output couplers were tested, the reflectivities of which are listed in Table 2. The radii of curvature for these output couplers was 100 mm, 100 mm and 50 mm, for OC 1, 2 and 3, respectively.

TABLE 2
Reflectivites of the tested output couplers at λₚ, λ_{1S}, and λ_{2S}.

| OC # | R_{2S} (%) | R_{1S} (%) | Rₚᵤₘₚ (%) |
|---|---|---|---|
| 1 | 11 | >99.9 | >99 |
| 2 | 45 | >99.9 | >99 |
| 3 | 96.5 | 98.8 | >99 |

The pump laser used in these experiments was similar to the one used in [14]: a quasi-CW Nd:YAG laser producing up to 270 W on-time power during a 250 μs pulse with M²<1.2 beam quality. On-time durations of as little as 100 μs are more than sufficient to obtain steady-state thermal gradients in diamond under tight focussing [14]. Thus power scaling and beam quality from the diamond laser under this regime is comparable to CW operation.

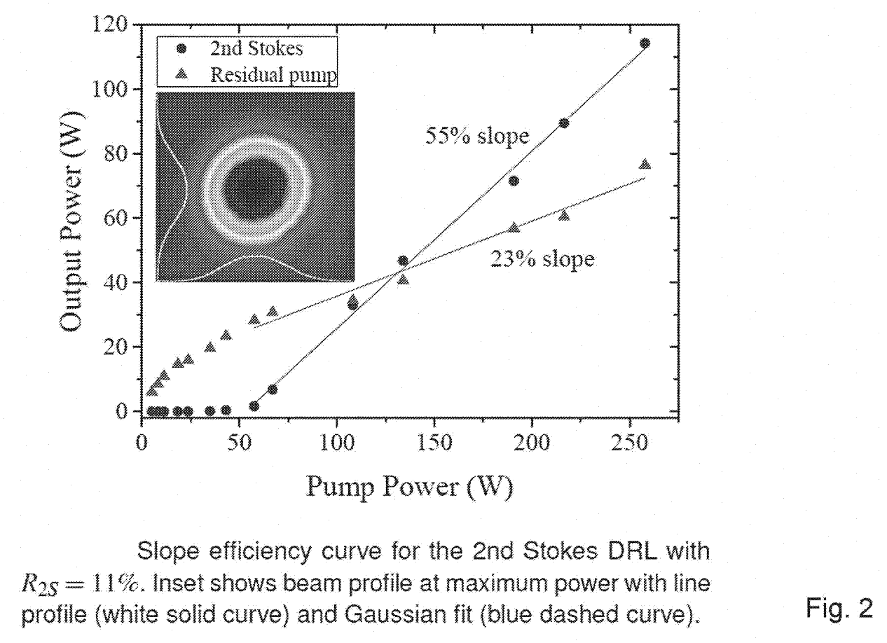

As shown in FIG. 2, using OC 1 (R₂₅=11%), the laser operated on the 2^{nd} Stokes shift with a threshold of approximately 53 W, above which the output increased linearly with a slope of 55% to a maximum of 114 W output at 1.49 μm from 258 W of injected pump power at 1.06 μm. The maximum conversion efficiency was found to be 44%, which exceeds many reported CW 1st-Stokes diamond lasers despite the larger quantum defect for 2nd Stokes operation, and is comparable to nanosecond-pulsed diamond lasers operating at this wavelength (40-51% [12, 13]). The output power was pump limited with no indication of output saturation, and the 2nd Stokes beam profile at maximum power was Gaussian (as shown in the inset in FIG. 2). Due to the high reflectivity of OC 1 at the pump and 1st Stokes wavelengths, the spectral purity of the output measured with a spectrometer was >99%.

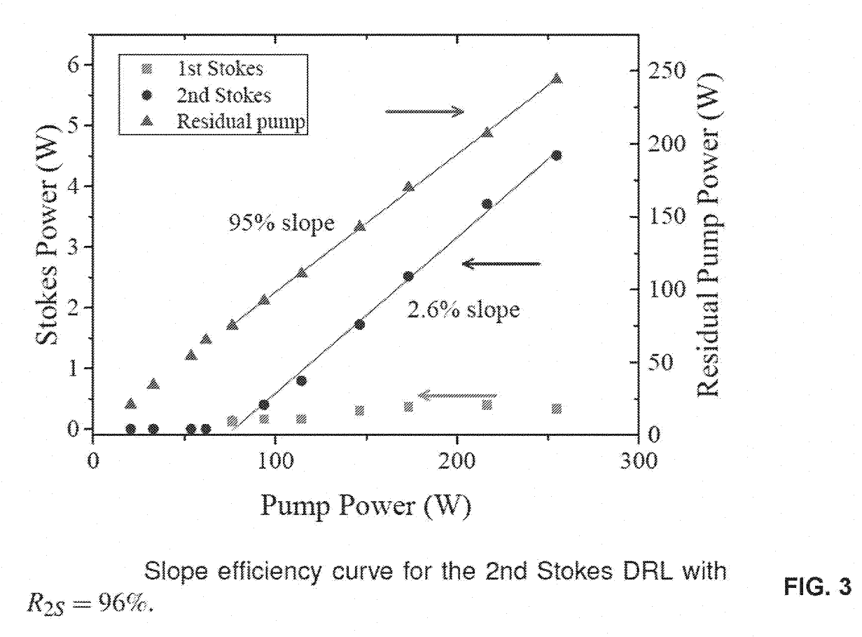

The diamond laser operated with reduced conversion efficiency and increased residual pump for OC 2 and 3, as expected from the model. For the case of OC 2 the 2nd Stokes threshold and slope efficiency were 27 W and 36%, respectively. And for OC 3, the 2nd Stokes threshold and slope efficiency were 77 W and 2.6%, respectively (see FIG. 3). The increased threshold for OC 3 is due to the significant 1st Stokes output coupling for this mirror (1.2%), giving rise to a much higher 1st Stokes threshold.

The residual pump light in each case increased linearly above the 2nd Stokes threshold, as expected from the model. The gradients of the residual power as a function of input power were 23%, 48% and 95% for OC 1, 2 and 3, respectively. By calculating the extracted pump power as the 2nd Stokes output divided by the quantum defect η₁ η₂, it was found that the sum of the slopes of the residual pump and extracted pump account for >99% of the injected pump power above threshold for the case of OC 1, and >98% for the cases of OC 2 and 3, affirming the results of the model: namely that above the 2nd Stokes threshold, the 1st Stokes field is clamped and all further depleted pump is converted to 2nd Stokes.

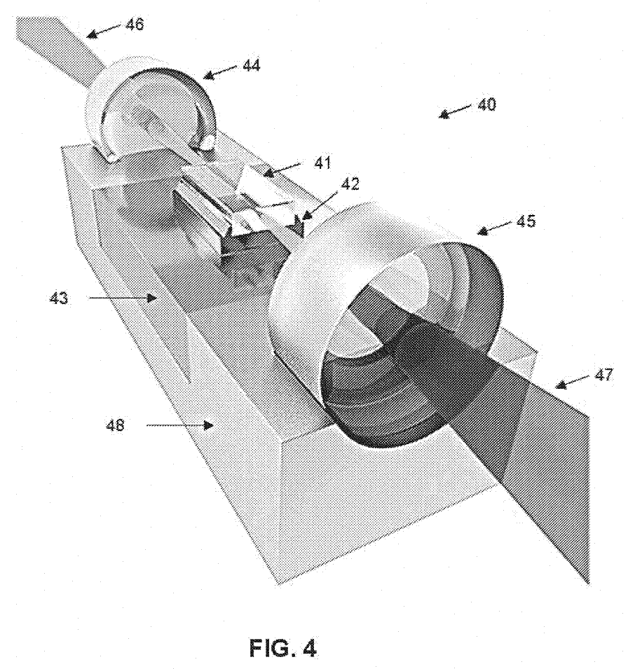

The conversion efficiency of these lasers is less than predicted by the model, and the slope of the residual pump is correspondingly higher in each case (particularly OC 1 and 2). For instance, the model predicts that OC 1 should yield a slope efficiency of 68% rather than 55%. This could be attributed to non-optimal alignment of the pump waist with the Stokes mode in the cavity, since the depletion of the pump between the threshold for 1st and 2nd Stokes lasing is not as high as usually observed. In the ideal case, the slope of the residual pump should be negative while only the 1st Stokes is above threshold (see FIGS. 2 and 4 in [11]); whereas in all cases here the slope is positive. Therefore higher efficiency operation may be achievable with OC 1 than shown here. Further alignment optimization was avoided in this instance due to damage to mirror coatings experienced at high pump powers, most likely caused by large intensity spikes in the leading edge of the Nd:YAG pump laser cycles (see FIG. 4 in [14]), which are not present in CW high-power pump sources such as fiber lasers.

Major considerations for further power scaling of this laser are thermal lensing and damage to optical coatings. In terms of optical coating damage, the system design presented here is quite robust. The 1st Stokes intra-cavity intensity is clamped above threshold (around the 20 kW level according to the model), thus the risk of damage from this circulating field is not increased at higher powers. Since the output coupling used here for efficient 2nd Stokes generation is as high as 89%, the 2nd Stokes intra-cavity intensity will not approach that of the 1st Stokes until well-into the kW output power level.

In terms of thermal lensing, the 2nd Stokes laser benefits from negligible power loss of the 2nd Stokes in the diamond due to the high output coupling. As noted above, by accounting for the residual pump power, the 2nd Stokes output power and the quantum defect, it is found that <1% of the generated 2nd Stokes power is dissipated in the diamond due to parasitic effects such as defect and impurity absorption and scatter. The power dissipated due to these effects due the first Stokes field is fixed for pump powers above 2nd Stokes threshold. Thus when increasing the 2nd Stokes power, the major contributor to the heat load is the generated Raman phonons. Whereas in 1st Stokes CW diamond lasers where the output coupling is much lower (often less than 1%), the power loss into the diamond can be 10-50% or more of the generated Stokes power [10, 14] (given by the ratio of diamond loss to total losses including output coupling). Therefore, the impurity and defect absorption contribution to the heating of the Raman material is greatly reduced in the optimized second Stokes laser. For the 1.06 to 1.49 μm 2nd Stokes shift, this amounts to 28% of the depleted pump power (equal to 40% of the output 2nd Stokes power). Comparing to previous results for 1st Stokes diamond Raman lasers where combined heating from 1st Stokes loss in the diamond and Raman-generated phonons amounted to approximately 150 W [14] and 120 W [10] for a 108 W laser and a 380 W laser, respectively (calculated as P_{Heat}=P_{Out}×[2αL/T_{OC}+(1−η1)/η₁], where T_{OC} is the output coupler transmission and P_{Out} is the measured Stokes output), the 2nd Stokes laser is able to approach 375 W output without exceeding those levels of heating. Power scaling beyond that level is likely with increased mode sizes without loss of beam quality, but will require significant heat extraction from the diamond.

The embodiments provide for a CW, 2nd Stokes crystalline Raman laser in an external cavity configuration. An analytical model reveals an almost linear proportionality between the 2nd Stokes output coupling and the depletion rate of the pump and thus that high output coupling at the 2nd Stokes is required for efficient conversion.

Utilizing the excellent thermal properties of diamond and the large Raman shift, we showed efficient conversion from 1.06 μm to 1.49 μm with up to 114 W output power, 55% slope efficiency and 44% conversion efficiency. This compact laser is well-suited for direct conversion of Yb fiber lasers to the 1.5-1.6 μm spectral range and shows excellent potential for further power scaling beyond the current capabilities of fiber lasers operating at these wavelengths. Pump laser linewidths less than approximately 50 GHz are preferred in order to ensure high Raman gain the diamond. The diamond may be cooled below room temperature to improve its thermal properties and hence potential for handling high power. It may be an anti-reflection-coated crystal or a Brewster cut crystal. It may be an isotopically purified crystal. When using anti-reflection coatings, it is especially critical to provide low reflection for odd-order Stokes wavelengths. Relaxation of the anti-reflection requirements for even orders may have practical advantages for sourcing high damage threshold and lower cost coatings.

Turning now to FIG. 4, there is illustrated a side perspective view of one form of operational portions of a suitable Raman laser 40 constructed with the teachings of the embodiments. In the arrangement 40, a diamond optical medium 41 is provided and mounted on a heat sink 42 and base 43 which can be formed from a high thermal conductivity material such as copper. The base 43 can further be mounted on stage 48. Also formed on the stage 48 are two reflective mirrors 44, 45 having reflectivites as outlined in table 2. The arrangement 40 is pumped by input beam 46, and produces output beam 47.

Whilst the initial embodiment has been described with reference to a single laser gain cavity, it will be evident to those skilled in the art that other forms of arrangement could be utilised, including ring cavity lasers and multi mirror arrangements.

### FURTHER EMBODIMENT

In a further embodiment, there is provided a Raman laser which allows for efficient frequency conversion of mature laser systems to selected emission wavelengths suitable for trace gas detection. Apart from compactness, the significant main advantages of Raman lasers are the automatic phase matching, which diminishes thermal dephasing and detuning, as well as the so called Raman beam-cleanup effect. The latter describes the fact that the spatial gain profile experienced by the generated Stokes beam is a convolution of the pump and Stokes fields which converges to a Gaussian distribution, thus providing fundamental transverse mode (TEM00) output and diffraction limited beam quality.

Furthermore, recent studies have shown that single-longitudinal mode operation, which is a prerequisite for narrowband laser emission, is facilitated in Raman lasers due to the lack of spatial hole burning in standing-wave cavities. CVD diamond has been demonstrated an excellent material for high-power frequency conversion due to its large high Raman gain coefficient and its beneficial thermo-mechanical properties, which in combination with the Raman beam cleanup effect, avoids detrimental thermal lensing and offers high-brightness output.

Diamond Raman lasers additionally allow for the generation of frequency-stable and narrowband output at selected absorption lines in the near-infrared spectral region. For this purpose, an external cavity diamond Raman laser operating in single-longitudinal mode (SLM) was developed which was tunable from 1483 to 1488 nm, while water vapor in the ambient air was chosen as absorbing gas species to demonstrate the laser's potential for trace gas detection. Water vapor is a principal green house gas due to its large atmospheric abundance and its role as a key amplifier of global warming. Precise measurement of the atmospheric water vapor concentration is therefore essential to check and improve climate models and to provide more accurate climate change and weather predictions.

The embodiment includes the utilization of a volume Bragg grating (VBG) on the spectral properties of the Raman laser. VBGs are compact and robust optical elements for spectral narrowing and mode-selection in lasers. The embodiment also shows the effective mode spacing of a SLM Raman laser which scales with the Stokes order, thus facilitating single-mode operation in higher-order Stokes Raman lasers.

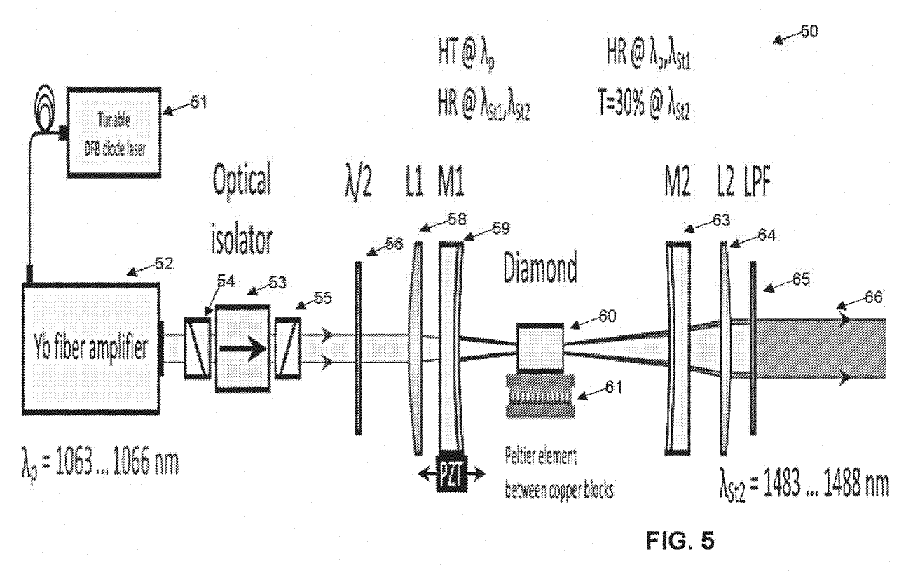

FIG. 5 illustrates schematically 50 an initial setup of an external cavity second Stokes Raman laser. The output from a single-frequency distributed feedback (DFB) laser 51 (TOPTICA Photonics, model DL DFB BFY), is amplified by an Yb fiber amplifier 52 (IPG Photonics, model YAR-LP-SF), and employed as a pump source, delivering up to 40 W CW output power at diffraction-limited beam quality (M²=1.05) and high frequency stability (40 MHz over one hour). The pump wavelength was tunable in the range from 1062.8 to 1065.6 nm by varying the operating temperature of the DFB laser 51 with a thermal tuning rate of 80 μm/K.

Optical feedback between the pump and the Raman laser was prevented by using an optical isolator 53 and polarization aligner 54, 55. A half-wave plate 56 was utilized to ensure polarization of the pump radiation along the [111] axis of a diamond medium 60, thus providing highest Raman gain. A plano-convex lens 58 with f_{L}1=50 mm focal length was used to focus the pump beam into the low-nitrogen, low-birefringence, CVD-grown single-crystal diamond (ElementSix, Ltd.) 60 which was placed on a copper block 61 in the center of a near-concentric optical cavity.

The linear Raman oscillator was formed by two concave mirrors 59, 63, with radii of curvature of 50 mm and 100 mm, respectively. Both mirrors were highly reflective at the first Stokes wavelength, generating intracavity first Stokes field powers in the kW range. The input coupler (M1 59) was also highly reflective at the second-order Stokes radiation, while the output coupler (M2 63) partially transmitted this component (T 30%).

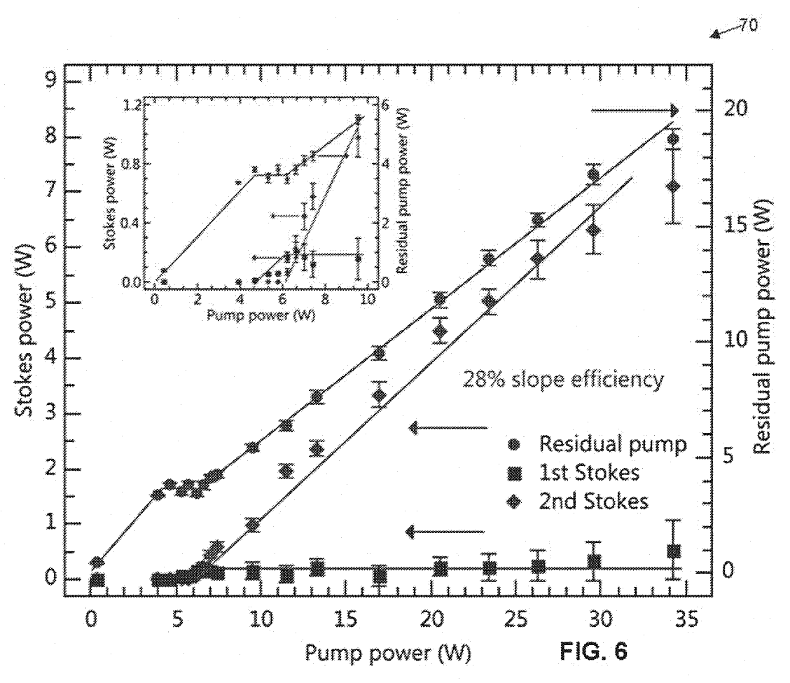

FIG. 6 shows the measurement of the 1st (e.g. 74) and 2nd (e.g. 73) Stokes laser performance 70 showing a low threshold (≈6 W) for both first and second Stokes generation, while the first Stokes power remained nearly constant once the second Stokes field arose. Above the second Stokes threshold, the first Stokes field acts as a mediator between the pump (71) and the second Stokes fields, so that efficient conversion to the latter is achieved. The maximum second Stokes power was measured to be 7 W at 34 W pump power, corresponding to a conversion efficiency of 21%.

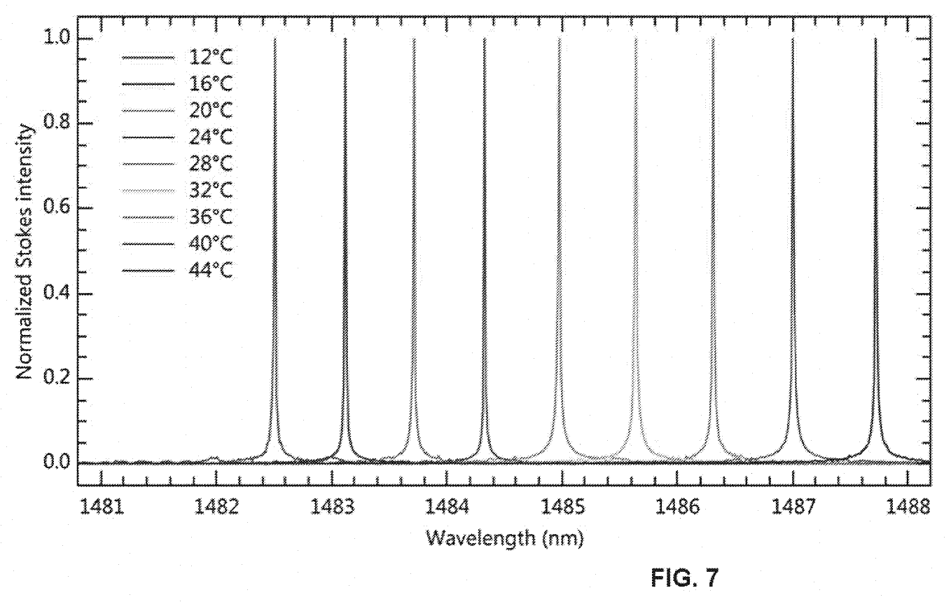

The output wavelength can be continuously tuned by varying the temperature of the DFB pump laser diode (51, FIG. 5), realizing a tuning range from 1483 to 1488 nm. The resulting spectra is depicted in FIG. 7, which was taken using a laser spectrum analyzer. The smooth Lorentzian line shape indicated SLM operation of the Raman laser at low output power of about 100 mW. This was also confirmed by the high stability of the center frequency which was only limited by the pump frequency fluctuations (40 MHz). However, multi-mode operation and much larger variations were observed at increased output power. Thermally induced changes in Raman shift and optical path length are considered to be the major reason for limiting the SLM power. The heat from the decay of Raman-generated phonons is approximately double compared to a first-Stokes laser. Also, due to impurity and defect absorption induced by the strong intracavity first Stokes field, thermal loading of the diamond may be aggravated compared to the first Stokes Raman laser. This results in a stronger coupling between Stokes power and optical cavity length and, consequently, in a reduced maximum SLM output power and poor frequency stability.

Wavelength Stabilization Using a Volume Bragg Grating

In order to increase the SLM power and to improve the frequency stability on longer time scales, a volume Bragg grating design (VBG) was incorporated into the system.

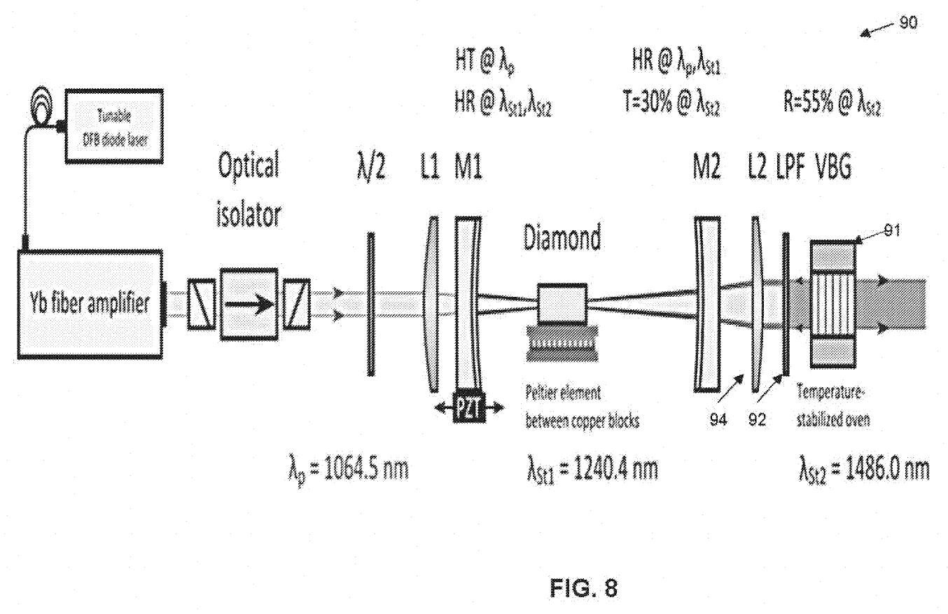

FIG. 8 illustrates 90 the utilization of a VBG 91 in a modified design. The VBG was designed to have a peak diffraction efficiency (reflectivity) of 55% at 1486.0 nm wavelength at normal incidence to the grating with a reflection bandwidth of about 100 μm (FWHM). In this way, it acted as a second output coupler of an outer optical resonator, providing optical feedback to the inner laser cavity which was formed by the two mirrors M1 and M2. A plano-convex lens, placed behind M2, collimated the output radiation, thus ensuring good spatial overlap of the second Stokes beams incident and reflected from the VBG, while a long-pass filter (LPF) 92, which was highly transmissive at the second Stokes wavelength, was utilized to suppress the pump and first Stokes radiation leaking through the inner cavity. Wavelength tuning of the VBG-stabilized Raman laser was accomplished by scanning the pump laser wavelength in combination with heating the grating 91 in a temperature-controlled oven. The latter allowed the VBG peak wavelength to be tuned from 1486.0 to 1486.6 nm with an accuracy of about 1 μm (135 MHz).

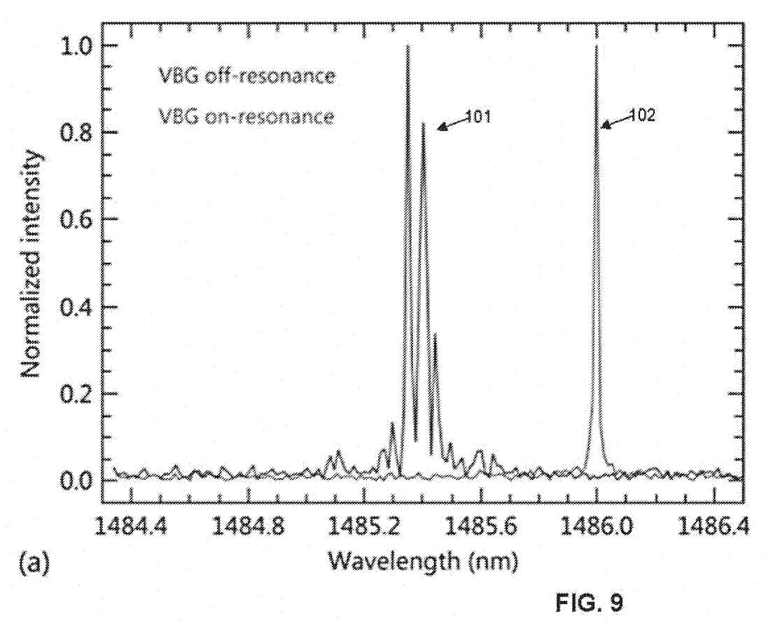

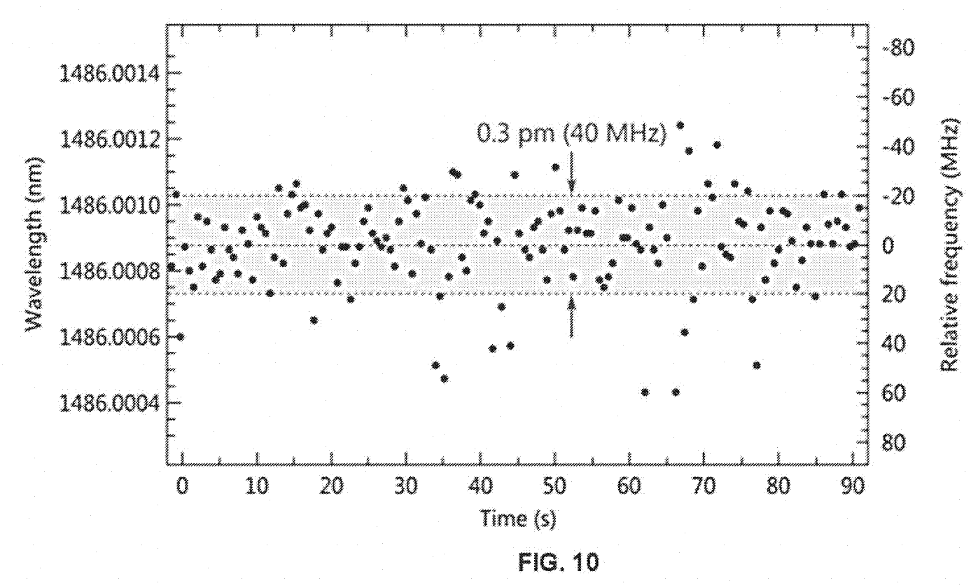

The influence of the VBG on the spectral purity of the Raman laser was investigated by recording its spectrum in case the second Stokes wavelength is tuned on- or off-resonance with the grating peak. FIG. 9 shows both cases 101, 102, measured at 500 mW output power. The VBG is shown off resonance 101 and on resonance 102. Multi-mode operation was evident when the Raman laser was tuned off-resonance 101 so that the VBG was transparent for the second Stokes radiation, whereas oscillation of a single longitudinal mode 102 was observed when the pump laser wavelength was set such that the second Stokes wavelength matched the room temperature VBG peak wavelength at 1486.00 nm and optical feedback was provided. FIG. 10 shows the stability of the center wavelength was about 40 MHz over periods of one to two minutes, which is in the order of the pump frequency fluctuations. Hence, the utilization of the VBG facilitates SLM operation as it improves the mode discrimination despite its broad bandwidth of about 100 μm.

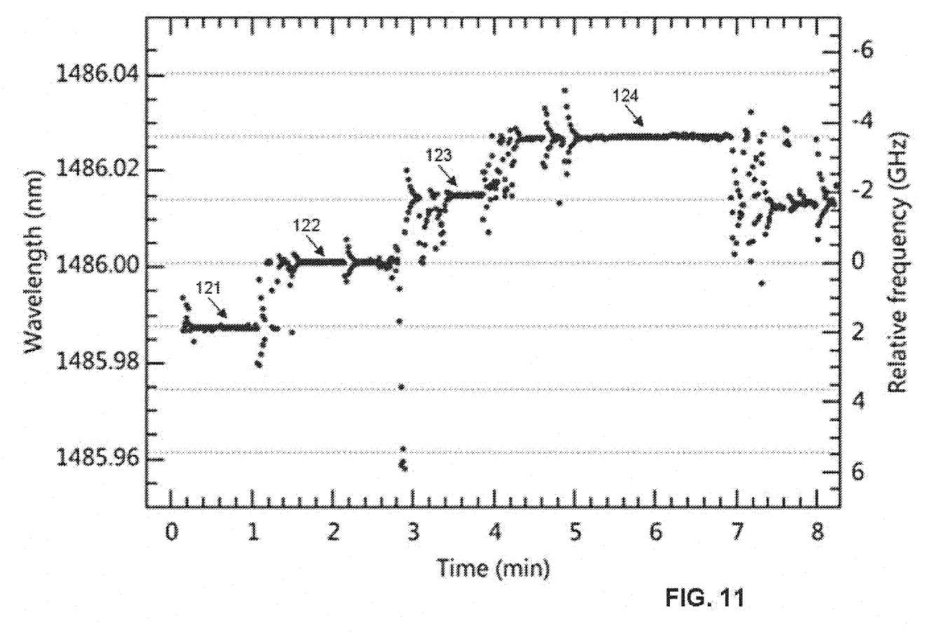

Measurement of the temporal variation of the center wavelength over several minutes revealed the occurrence of mode-hops as illustrated 121, 122, 123, 124 in FIG. 11. These are thought to be due to heating of the diamond and its mount. Owing to the strong intra-cavity first Stokes field, the diamond heats up by tens of Kelvin within a few minutes, which leads to an increase of the optical path length and also affects the centre value of the Raman shift. The mode-hops were measured to be in the order of 2 GHz which is twice the mode spacing calculated from the optical length of the inner cavity.

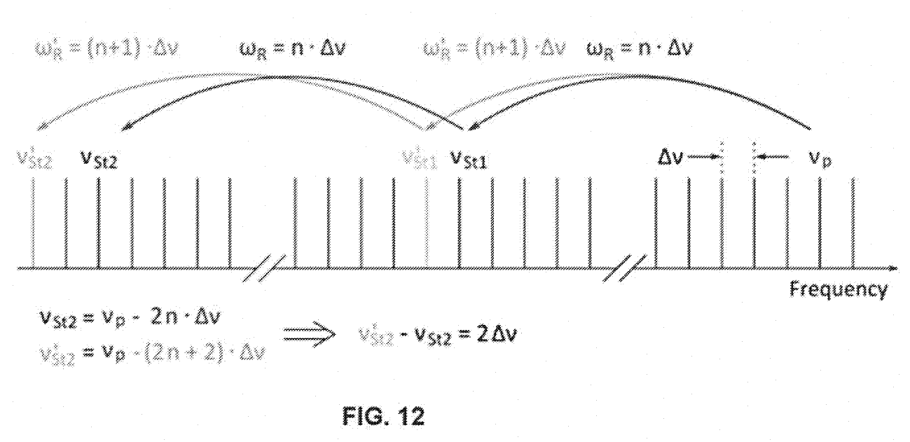

Without wishing to be bound by theory, the reason is perhaps explained as follows. In the case of SLM operation of the first Stokes component, the corresponding field is necessarily in resonance with the same cavity as the pump, which implies that the frequency is an integer multiple of the inner cavity mode spacing Δv, as illustrated in FIG. 12, and lies close to the peak of the Raman gain near 1240 nm. The second Stokes mode will experience gain due to the first Stokes field as its pump, and be seeded by spontaneous Raman scattering and the result of non-phase-matched four-wave mixing of the fundamental frequency v₀ with the first Stokes frequency v_{St1}=v₀−n·Δv, where n is a positive integer. While the former process potentially seeds all cavity modes, the latter only provides a seed at 2 v_{St1}−v₀=v₀−2n·Δv due to energy conservation. Hence, it is deduced from the observed mode hop interval of 2Δv that four-wave mixing is the dominant seeding mechanism. Consequently, the second Stokes field is in resonance with the first Stokes Raman cavity as well.

If a mode-hop occurs for the first Stokes laser, the phonon frequency (Raman shift) is increased (or decreased) by the amount of the cavity mode spacing. This results in a larger (or smaller) shift from first to second Stokes, so that one mode is skipped and the effective mode spacing is twice as large as for the first Stokes. This concept can be transferred to even higher Stokes orders. As the frequency spacing increases in proportion to the Stokes order, the number of available longitudinal modes within the Raman gain bandwidth is reduced. This is a useful feature as it enables secondary modes to be more easily discriminated, e.g. by frequency selective cavity elements and thus assists in SLM stability.

It should be noted that the above explanation presumes that the optical lengths of the coupled cavities formed by M1 and the VBG and M1 and M2 are chosen such that they are in resonance. However, due to low finesse of the cavity formed by the VBG, which is further diminished by intracavity losses introduced by lens L2 and the long-pass filter, the exact cavity lengths are of minor importance for stable SLM operation of the second Stokes laser. In general the mirror spacings should be accurately controlled with active mirror positioners and feedback electronics to ensure stable single mode operation.

SLM operation of a diamond Raman laser emitting in the eye-safe spectral region was demonstrated in the alternative embodiment. Efficient frequency conversion of a tunable pump laser to the second order Stokes component produced 7 W multi-mode output power in the range from 1483 to 1488 nm. Implementation of a volume Bragg grating increased the single-mode output power to 500 mW, while reducing the frequency fluctuations to 40 MHz. Analysis of the long-term frequency stability revealed that the effective mode spacing of the Raman laser is twice the cavity mode spacing and provides a beneficial inherent property of higher-order Raman lasers when operating SLM. Finally, the Raman laser was successfully employed for water vapor detection.

Significant reduction of the measurement error can be found by improving the laser frequency stability, e.g. by using a VBG whose room temperature peak wavelength matches the center wavelength of the selected absorption line.

Detection of other gas species can be accomplished by adapting the current system to use a greater fraction of the Yb fiber amplifer gain spectrum (e.g. from 1010 to 1120 nm), thus enabling access to major portions of the near-infrared via first (1165-1320 nm) and second Stokes (1380-1600 nm) generation. Therefore, it is expected that SLM Raman lasers based on the developed concept represent a promising alternative to existing OPO/OPA and Er:YAG laser sources applied for remote sensing of atmospheric gases. Furthermore, extension of the available emission wavelengths to the visible spectral range can be achieved by subsequent second harmonic generation, reaching, for instance, 698 nm which represents the wavelength of the 1S0→3P0 clock transition in Sr atomic clocks.

The embodiments show the potential for power scaling, especially of diamond Raman lasers, opening new opportunities for developing high-power SLM lasers which are of great interest not only for remote sensing applications, but also for other areas such as gravitational wave detection and laser cooling.

### FURTHER ALTERNATIVE EMBODIMENTS

The forgoing arrangements can be generalised to multi Stokes cascades. This can result in Cascaded-Stokes long-pulsed and continuous-wave Raman lasers using an external cavity with non-resonant or weakly resonant pumping.

The design parameters allow for efficient, long-pulsed or continuous-wave Raman beam conversion in crystals using non-resonant or weakly-resonant pumping of an optical cavity resonant at more than one Stokes wavelength, in order to convert energy from the pump beam to a Stokes-shifted beam via two or more cascaded Stokes shifts.

The embodiments thereby allow output coupling values required to achieve efficient conversion at Stokes orders of two or greater.

The general equation governing the pump conversion in a second Stokes CW external-cavity Raman laser is:

$${I}_{p} ( 0 ) = \frac{γ \overline{{I}_{1} ( z )}}{1 - exp [ - γ \overline{{I}_{1} ( z )} ]} ( {I}_{{pTH}_{1}} + \overline{{I}_{2} ( z )} ) ,$$

where Ip(0) is the injected pump intensity; γ=4g₁L/η₁, where g₁ is the Raman gain coefficient at the first Stokes wavelength, L is the length of the gain crystal and η₁ is equal to the pump wavelength divided by the first Stokes wavelength; I̅₁̅(̅z̅)̅ and I̅₂̅(̅z̅)̅ are the average intensities of the circulating first and second Stokes fields, respectively, over one round-trip; and I_{pTH1}=(−ln R₁+2α₁L)/(4g₁L), where R₁ is the cavity reflectivity at the first-Stokes wavelength (i.e. the product of the reflectivity of the two mirrors) and α₁ is the loss coefficient of the diamond at the first Stokes wavelength.

This equation applies to double-pass pumping; whereas for single-pass pumping γ=2g₁L/η₁ and there is a factor of two in front of the second-Stokes term (i.e. I̅₂̅(̅z̅)̅ is replaced with 2̅I̅₂̅(̅z̅)̅).

For a first Stokes only laser I̅₂̅(̅z̅)̅=0. For a second Stokes laser

$$\overline{{I}_{1} ( z )} = \frac{- ln {R}_{2} + 2 {α}_{2} L}{4 {g}_{2} L} .$$

For higher cascaded Stokes orders it is possible to substitute any odd order for I̅₁̅(̅z̅)̅ and any even order for I̅₂̅(̅z̅)̅ using the following equation which is true for all Stokes orders:

$$\overline{{I}_{n} ( z )} = \overline{{I}_{n - 2} ( z )} - \frac{- ln {R}_{n - 1} + 2 {α}_{n - 1} L}{4 {g}_{n - 1} L} ,$$

where Rₙ₋₁ is the cavity reflectivity at the (n−1)th Stokes wavelength, αₙ₋₁ is the crystal loss coefficient at the (n−1)th Stokes wavelength, and gₙ₋₁ is the Raman gain coefficient at the (n−1)th Stokes wavelength.

As an example, for a fifth-Stokes laser, the pump intensity required to achieve a given intracavity fifth-Stokes intensity is given by

$${I}_{p} ( 0 ) = \frac{γ ( \overline{{I}_{5} ( z )} + \frac{- ln {R}_{4} + 2 {α}_{4} L}{4 {g}_{4} L} + \frac{- ln {R}_{2} + 2 {α}_{2} L}{4 {g}_{2} L} )}{1 - exp [ - γ ( \overline{{I}_{5} ( z )} + \frac{- ln {R}_{4} + 2 {α}_{4} L}{4 {g}_{4} L} + \frac{- ln {R}_{2} + 2 {α}_{2} L}{4 {g}_{2} L} ) ]} \times ( {I}_{{pTH}_{1}} + \frac{- ln {R}_{3} + 2 {α}_{3} L}{4 {g}_{3} L} + \frac{- ln {R}_{5} + 2 {α}_{5} L}{4 {g}_{5} L} ) .$$

And for a fourth-Stokes laser, the pump intensity required to achieve a given intracavity fourth-Stokes intensity is given by

$${I}_{p} ( 0 ) = \frac{γ ( \frac{- ln {R}_{4} + 2 {α}_{4} L}{4 {g}_{4} L} + \frac{- ln {R}_{2} + 2 {α}_{2} L}{4 {g}_{2} L} )}{1 - exp [ - γ ( \frac{- ln {R}_{4} + 2 {α}_{4} L}{4 {g}_{4} L} + \frac{- ln {R}_{2} + 2 {α}_{2} L}{4 {g}_{2} L} ) ]} \times ( {I}_{{pTH}_{1}} + \frac{- ln {R}_{3} + 2 {α}_{3} L}{4 {g}_{3} L} + \overline{{I}_{4} ( z )} ) .$$

The output power at any given Stokes line can be calculated from the intracavity intensity using the following equation:

Pₙ=+ln RₙAI̅ₙ̅(̅z̅)̅,

where A is the area of the beam in the crystal.

The above derived analytical equations describing steady-state intra-cavity intensities for cascaded Stokes lines reveal that all odd-order Stokes shifts have a similar relationship to the injected pump intensity and therefore that optimal output coupling values are similarly low for efficient conversion to all odd-order Stokes shifts. Similarly, the intra-cavity intensities of all even-order oscillating Stokes shifts have a similar relationship to the injected pump intensity, one that is very different to that of the odd Stokes orders, and therefore optimal output coupling values are similar for efficient conversion to all even-order Stokes shifts.

The derived analytical equations also include the solution for efficient conversion to the 2nd Stokes, revealing that comparatively very high output coupling values are required for optimal conversion efficiency for all even-order Stokes shifts, compared to the optimal values for odd-order Stokes shifts.

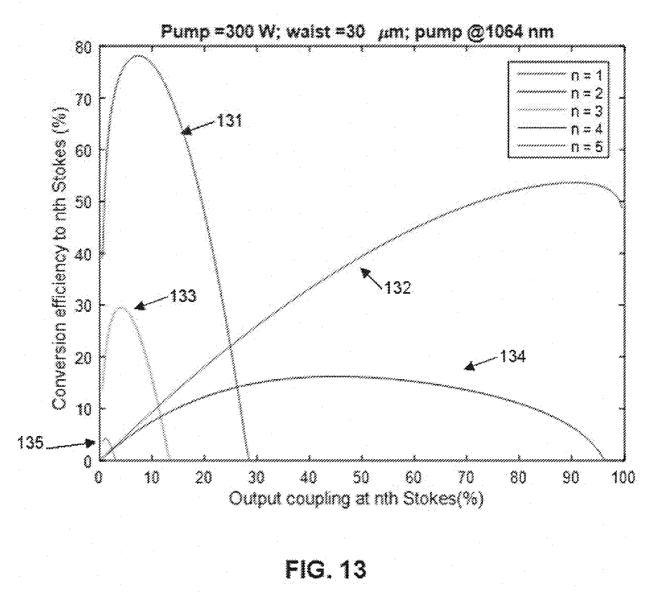

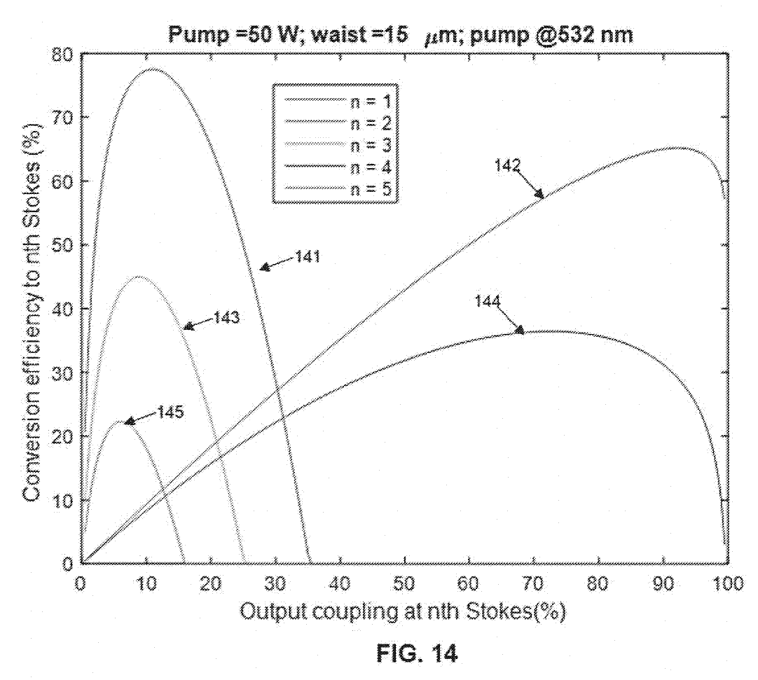

These trends are clearly illustrated in FIG. 13 and FIG. 14, which plot total power conversion efficiency as a function of final (nth-) Stokes output-coupling for diamond Raman lasers with output at the 1st, 2nd, 3rd, 4th and 5th Stokes shifts from the pump. FIG. 13 illustrates a graph of the model results for an external-cavity diamond Raman lasers for output couplings at the 1st, 2nd, 3rd, 4th or 5th Stokes shift (131-135) under 1.06 μm pumping with 300 W pump power focussed to a spot of 30 μm radius in the diamond, neglecting multi-phonon absorption in diamond at the 4th and 5th Stokes shifts (2.5 μm and 3.7 μm).

FIG. 14 illustrates a graph of the model results for an external-cavity diamond Raman lasers for output coupling at either the 1st, 2nd, 3rd, 4th or 5th Stokes shift (141-145) under 0.53 μm pumping with 50 W pump power focussed to a spot of 15 μm radius in the diamond.

The plots were generated by solving the above analytical equations. In all cases, the output coupling is small (approximately zero) for all Stokes wavelengths of lower order (<n) than the final (n^{th}) Stokes wavelength, and high enough at higher cascaded Stokes wavelength (n+1^{th}) in order to suppress unwanted further cascading. The derived solution is more generally applicable, for example, for simultaneous output at multiple Stokes orders.

Two cases are presented. In FIG. 13, with 300 W pumping at 1.06 μm, and FIG. 14. 50 W pumping at 0.53 μm. FIG. 13 and FIG. 14 clearly show highest conversion efficiency for output coupling values of less than 20% for odd-order Stokes shifts, compared with much higher optimal output coupling values for even-order Stokes shifts (greater than 60% for most of the cases presented in FIG. 13 and FIG. 14).

The parameters used in the model to generate FIG. 13 are as follows: Cavity loss due to mirror reflectivity at intermediate Stokes orders: −log(0.999); cavity loss due to mirror reflectivity at the (n+1) Stokes order: −log(0.0000001); injected pump power: 300 W; pump and all Stokes waist radii in diamond: 30 μm; gain medium length: 0.8 cm; distributed loss coefficient in the gain medium at all Stokes wavelengths: 0.00375 cm⁻¹; Raman gain coefficient at 1st Stokes: 10 cm/GW; Stokes wavelengths (in order from 1st to 6th): 1240 nm, 1485 nm, 1851 nm, 2457 nm, 3653 nm, 7119 nm; gain coefficients for 2nd and higher Stokes orders are proportional to gain at 1st Stokes and scale inversely with the square of the wavelength to account for the 1/λ, scaling of Raman gain and the λ scaling of the mode area in a resonator (which gives rise to an inversely proportional scaling of the beam intensity and thus Raman gain).

The parameters used in the model to generate FIG. 14 are the same as for FIG. 13 except for the following: Injected pump power, 50 W; pump and all Stokes waist radii in diamond, 15 μm; distributed loss coefficient in the gain medium at all Stokes wavelengths, 0.011 cm⁻¹; Raman gain coefficient at 1st Stokes, 20 cm/GW; Stokes wavelengths (in order from 1st to 6^{th} 141-146), 573 nm, 620 nm, 676 nm, 742 nm, 824 nm, 926 nm.

The intracavity intensity at the nth Stokes order is calculated by solving the above equation relating the 1st and 2nd Stokes intensities to the pump intensity and substituting for the 1st and 2nd Stokes (I₁(z) and I₂(z)) the terms representing the higher oscillating Stokes orders, according to the above equation. Because in this model the beam radii are set as constant and equal for the pump and all Stokes orders, the conversion efficiency for the nth Stokes order is calculated as the intracavity intensity at the nth Stokes multiplied by −log(Rₙ), divided by the injected pump intensity, where is the output coupler reflectivity at the nth Stokes wavelength.

The high optical loss in diamond at wavelengths corresponding to 4th and 5th Stokes shifts from 1.06 μm in diamond (2.5 μm and 3.7 μm), which occur due to lattice absorption, have not been accounted for in this model, as they are peculiar to diamond with this pump wavelength. These models are indicative of the trends in optimal output coupling due to the interacting gain and loss terms between the pump and various intra-cavity Stokes fields. In order to accurately model predicted performance at all wavelengths it would be necessary to substitute more accurate loss values for each Stokes wavelength into the equation rather than the assumed values given above.

The cause of poor conversion efficiency to even Stokes orders for low output coupling values is that the low output coupling results in a low rate of pump depletion per round trip, and since the pump is not resonated in the cavity this means that there is a low rate of power conversion from the pump in total.

Another important insight from the model is that in order to achieve an efficient nth-order Stokes laser where n is odd, it is necessary to minimize cavity reflections for the (n+1)th Stokes order to a high degree.

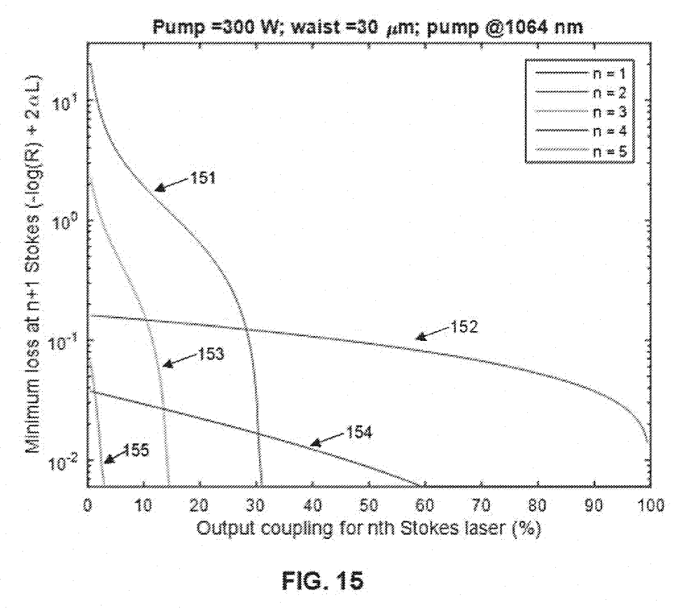

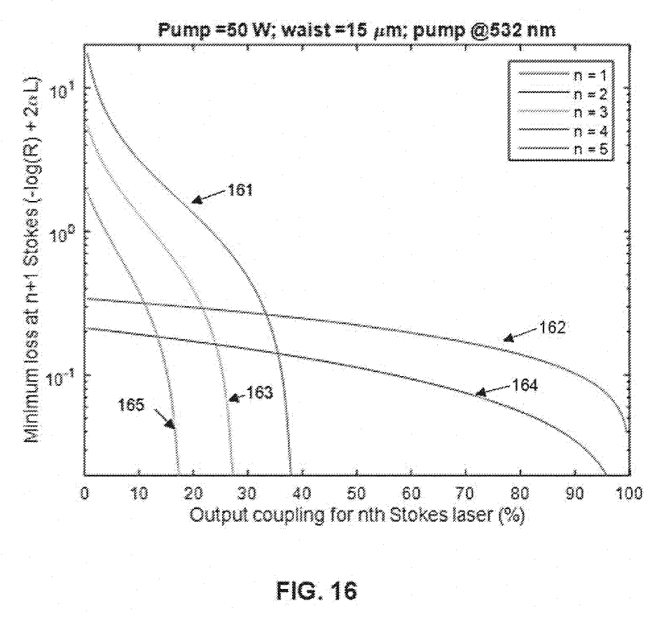

FIG. 15 and FIG. 16 show plots using the same analytical equations, and with the same parameters, to solve for the minimum required cavity loss at the (n+1)th Stokes order as a function of cavity output coupling at the desired (nth) Stokes order, in order to avoid cascading to the (n+1)th Stokes order. These solutions are given for 1st through 5th order Stokes lasers. It is shown that for an odd-order Stokes laser with output coupling <20% (near the optimum values given in FIG. 15), the minimum tolerable cavity loss for the next even Stokes order is typically very high. Whereas, for the even Stokes order lasers (n=2,4,etc) the minimum required losses for the (n+1)th Stokes order are relatively low across the whole range.

FIG. 15 and FIG. 16, plots the minimum required loss at the (n+1)th Stokes order for a nth Stokes laser, in order to avoid cascading to the (n+1)th Stokes order (which clamps the nth Stokes output for increased pump power). Plots are given for identical parameters used in FIG. 15 to that previous applied with under 1.06 μm pumping with 300 W pump power focussed to a spot of 30 μm radius in the diamond, neglecting multi-phonon absorption in diamond at the 4th and 5th Stokes shifts (2.5 μm and 3.7 μm). FIG. 16 shows under 0.53 μm pumping with 50 W pump power focussed to a spot of 15 μm radius in the diamond.

The practical implication of this result is that in order to make an efficient odd-order Stokes laser, including a 1st Stokes laser, special care must be taken to avoid cascading to the next even Stokes order, and the resultant clamping of the output power of the desired Stokes order. Whereas, for an efficient even-Stokes order laser, suppressing unwanted cascading to the next odd Stokes order does not place additional stringent requirements on cavity reflections/losses. This argument also applies to materials other than diamond that may have secondary high gain Raman modes (for example, potassium gadolinium tungstate). In this case, it is also important to provide sufficient loss at the corresponding wavelength of the Stokes shift of the secondary mode.

The benefits and disadvantages of low and high output coupling regimes for cascaded-Stokes Raman lasers will be as follows. For a given output Stokes order, a low output coupling or transmission often results in strong parasitic nonlinear effects, such as SBS and four-wave-mixing, a high proportion of parasitic losses (e.g. absorption and scattering) compared to output coupling, Poor pump depletion for the case of even-Stokes-order output coupling. For an odd-order Stokes laser, there is a high risk of unwanted cascading to next Stokes order, and clamping the output of the desired Stokes.

Where the output coupling or transmission is very high, the threshold increases (particularly for odd-Stokes-order output coupling) and thus the laser efficiency is decreased.

It can be seen that an outcome of the model is the efficiency of odd-order Stokes output and the suppression of the next higher order (even). This is much more stringent than for even-order Stokes output (as in FIGS. 15,16). In practice, this can be achieved by ensuring the cavity mirrors are highly transmitting at the higher order. Intracavity elements such as filters, etalons and absorbers may also be used to achieve suppression. A further technique for increasing the level of suppression is by using a folded cavity (eg., a bounce off an extra ‘folding’ mirror) and ensuring that the folding mirror has high loss at the higher order. In this case, the overall round-trip loss is at least double the mirror loss.

There is also the possibility for intracavity second harmonic generation at shorter wavelengths. In this case, the output coupling is instead provided by the nonlinear second harmonic generation that is outputted through the output coupler (that is made highly transmitting for the harmonic). The optimization of the output coupling occurs in a similar way to a partially reflecting mirror. The output coupling value will depend principally on the choices of nonlinear material, crystal length, size of the beam in the crystal.

Different lasers can also be used. In addition to Nd:YAG, likely pump lasers include Yb:YAG lasers, Yb fibre lasers, VECSELs and Er fibre lasers and their harmonics. The same principles as outlined here also apply to ultrashort Raman lasers (eg., picosecond Raman lasers) that are synchronously pumped.

Where a volume Bragg Grating is used, it will generally be important to stabilize or actively control the cavity length of the resonator mirror separations. This is a known requirement for tunable or wavelength stable lasers operating on a single longitudinal mode.

### Further Alternative Embodiment−Beyond the 2.1 μm Region

Solid-state laser sources emitting at wavelengths beyond 2.1 μm (the transmission window of silica optical fibers) are challenging to realise for many reasons—particularly in continuous-wave operation. Fiber laser sources based on soft glasses are not suitable for high powers, and most laser transitions are inefficient. High power lasers in this wavelength range are in demand for welding of plastics, particularly as plastics absorb light at these wavelengths without requiring additives or sensitisers.

Diamond can potentially overcome these issues using Raman lasing, which does not require laser transitions but rely on Raman frequency conversion from a shorter wavelength laser. There is a major demand to develop lasers in this wavelength region for, for example, plastics welding applications.

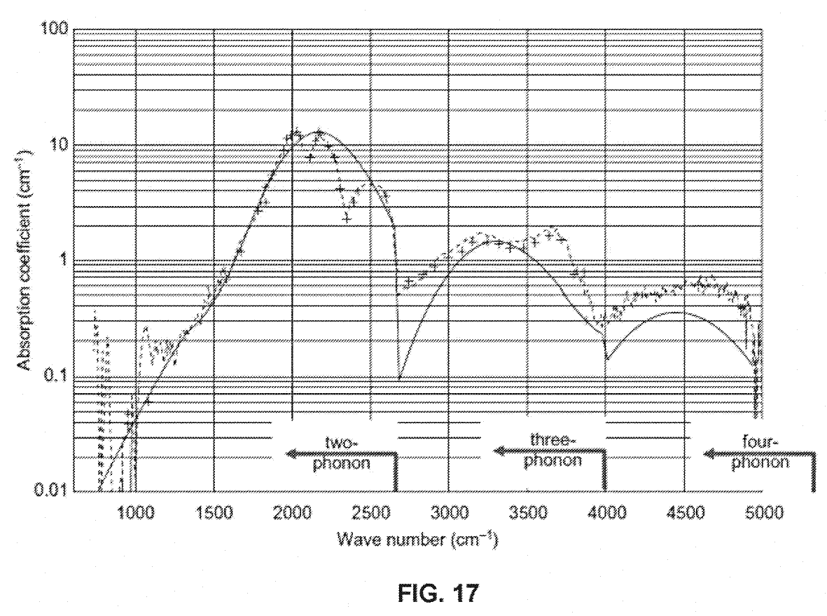

However, diamond also suffers from significant loss in the 2-3 μm wavelength region. This is thought due to the problem of intrinsic multiphonon absorption (lattice absorption) in the diamond which occurs at some degree at threshold wavelengths at 1.9 microns (4 phonon) absorption and much more strongly at 2.5 microns (3-phonon). (Two phonon starts at 3.75 microns). FIG. 17 illustrates a logarithmic graph of the absorption coefficient of diamond by wave number, showing the mulitphoton absorption characteristics. As a result, there is a particular need to provide a lasing system over this range.

Laser modelling suggests that diamond lasers operating at these wavelengths (or wave numbers), based on a single Raman shift, will have such high threshold power requirements and such low output efficiency as to make such an approach futile. For example, diamond loss at 2-3.8 μm is in the range 0.2-2 cm⁻¹ (cf. <0.004 cm¹ at 1.2 μm). For a typical diamond laser: 0.8 cm diamond with two passes through the crystal per round trip, the loss per round trip would be 27-96%, compared with 0.6% at 1.2 μm.

For an example, a 1st Stokes laser with λ_{Raman}=2.46 μm, λₚᵤₘₚ=1.85 μm, the loss coefficient at 2.46 μm, is α₂₄₆=0.3 cm⁻¹ (therefore the round-trip loss=62%), with mirror reflectivity R₁R₂=1×0.8=0.8, gain coefficient g=10⁻⁸×1240/2457 cm.W⁻¹, with a diamond length L=0.8 cm, the max. conversion efficiency is provided as follows:

$$\begin{matrix}max . conversion efficiency = \frac{1851}{2457} \times \frac{1 - {R}_{1} {R}_{2}}{1 - {R}_{1} {R}_{2} + 2 {α}_{2.46} L} \\ = 22 \% .\end{matrix}$$

In order to even approach the above conversion efficiency, the pump power of approximately four times the threshold pump power P_{threshold} is required:

$$\begin{matrix}{P}_{threshold} = π {w}_{0}^{2} \frac{- ln ( {R}_{1} {R}_{2} ) + 2 {α}_{2.46}}{4 gL} \\ = 1 , 230 W ,\end{matrix}$$

for a pump focal spot radius w₀=0.003 cm in diamond. With such an extremely high threshold and low prospects for efficient conversion even at multiple times above threshold, this type of laser is impractical with negligible prospects for any application.

This embodiment, utilises a cascaded continuous-wave Raman laser to achieve a laser design for operation at these wavelengths (or in any situation with high losses at the laser wavelength) that is capable of operating efficiently and with a much lower threshold pump power requirement. By operating on a second Stokes shift, which requires a low-finesse/high-gain cavity to operate efficiently, it is far less susceptible to parasitic losses than a Raman laser designed to operate on a first Stokes shift.

The examples discussed below provide for threshold powers and predicted slope efficiencies for a second Stokes laser designs.

High power solid state lasers operating at wavelengths between 2 and 3 μm have numerous applications. An immediate target application is plastics welding. The embodiment is directed to the theory and design principles to achieve efficient operation in the presence of substantial-to-high parasitic losses.

For a second Stokes laser operating at a similar output wavelength: λ_{Raman}=2.46 μm λ_{1S}=1.85 μm, λₚᵤₘₚ=1.49 μm, the loss coefficient at 2.46 μm α_{2.46}=0.3 cm⁻¹, the loss coefficient at 1.85 μm α_{1.85}=0.004 cm⁻¹, the Raman gain coefficient at 1.85 μm g₁=10⁻⁸×1240/1851 cm.W⁻¹, and an effective Raman gain coefficient at 2.46 μm (taking account of the expanded beam size for the second Stokes mode in the cavity compared to the first Stokes mode) g₂=10⁻⁸×(1240/2457)(1851/2457) cmW⁻¹, the mirror reflectivity for the first Stokes wavelength R²_{1.85}=0.996, the mirror reflectivity at the second Stokes wavelength R_{2.46}=R₁R₂=1×0.3=0.3, the pump waist radius in the diamond w₀=0.003 cm, and the diamond length L=0.8 cm. The threshold pump power for second Stokes lasing at 2.46 μm is calculated as follows:

$${P}_{threshold} = π {w}_{0}^{2} 4 {g}_{1} L \frac{1851}{1485} \frac{{th}_{1} {th}_{2}}{1 - exp [ - \frac{1851 \times 4 {g}_{1} {Lth}_{2}}{1485} ]} , where$$

$$\begin{matrix}{th}_{1} = \frac{- ln ( {R}_{1.85}^{2} ) + 2 {α}_{1.85} L}{4 {g}_{1} L} \\ = 466 , 100 W \text{·} {cm}^{- 2} , and\end{matrix}$$

$$\begin{matrix}{th}_{2} = \frac{- ln ( {R}_{2.46} ) + 2 {α}_{2.46} L}{4 {g}_{2} L} \\ = 138 , 400 , 000 W \text{·} {cm}^{- 2} ,\end{matrix}$$

$$\begin{matrix}∴ {P}_{threshold} = π {w}_{0}^{2} \times 1 , 767 , 500 \\ = 50 W .\end{matrix}$$

Therefore even with a much higher mirror transmission for the second Stokes case (which tends to increase threshold but also increase slope efficiency, particularly in a laser with high parasitic losses), the threshold pump power requirement is reduced more than 24 times compared to the first Stokes laser.

The slope efficiency of this laser above threshold is calculated to be 32%, which is quite high considering the energy loss due to the quantum defect with pumping at the shorter wavelength of 1.49 μm (1−1485/2457=40%) combined with the high parasitic loss at the laser wavelength. Therefore for 150 W pump power at 1.49 μm, approximately 32 W output at 2.46 μm can be obtained. This can therefore result in a practical and relatively efficient laser for the hard-to-reach 2.5 μm wavelength region.

The loss values for diamond stated in the examples above are approximate only. However, these examples clearly illustrate the vastly superior performance attainable from operation on a second Stokes shift at a lossy wavelength, compared to operation on a first Stokes shift.

Suitable pump sources around 1.5 micron include erbium fibre lasers, Raman fiber lasers and diamond Raman lasers. In the latter case, a two stage diamond laser arrangement can enable mature 1 micron fibre laser technology to be used as the main drive laser. A further alternative may be to use a 1 micron pump and operate the diamond laser at the 4th Stokes output. The use of second Stokes output to generate efficient output at a wavelength that is lossy in the cavity also applies to other even order Stokes wavelengths. A 4th Stokes laser is likely to be more simple compared to a two stage DRL, but the disadvantage that the specifications for the mirror coatings will be more challenging to meet.

### Interpretation

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A Raman Laser device having an nth Stokes shifted output, the device including:
a laser pump input;
a lasing cavity having feedback elements; and
a Raman active gain medium within the cavity, exhibiting first and higher Stokes emissions when subjected to pumping by the laser pump input;
wherein the feedback elements feeding back the pump input, and 1^{st} Stokes output from the gain medium, and a gain portion of the higher Stokes output, with a transmitting portion of the 24 nth Stokes output being the output of the device.

2. A device as claimed in claim 1 wherein the feedback elements comprise mirrors with high reflectivity at the first Stokes wavelength, with the output mirror having a lower reflectivity at a second Stokes wavelength.

3. A device as claimed in claim 2 wherein the mirror reflectivity at the first Stokes wavelength exceeds 98%.

4. A device as claimed in claim 2 wherein the output mirror has a reflectivity at the second Stokes wavelength of less than about 50%.

5. A device as claimed in claim 4 wherein the output mirror has a reflectivity at the second Stokes wavelength of less than about 12%.

6. A device as claimed in claim 1 wherein the laser pump provides a continuous wave input and the higher Stokes output is a continuous wave output.

7. (canceled)

8. A device as claimed in claim 1 wherein said Raman active gain medium comprises a low birefringence, low nitrogen diamond material.

9. (canceled)

10. A device as claimed in claim 1 wherein the laser pump input is tuneable, producing a tuneable 2^{nd} Stokes shifted output.

11. A device as claimed in claim 10 wherein said laser pump includes a tuneable DFB laser producing a first output which is amplified by a second laser amplifier to produce said laser pump input.

12. (canceled)

13. A device as claimed in claim 1 further comprising a volume Bragg grating (VBG) wavelength selective feedback element for filtering the feedback to the laser cavity.

14. (canceled)

15. (canceled)

16. A Raman Laser device having an nth Stokes shifted output the device including:
a laser pump input;
a lasing cavity having feedback elements at each end; and
a diamond Raman active gain medium within the cavity, exhibiting multiple cascaded Stokes emissions when subjected to pumping by the laser pump input;
wherein the feedback elements feeding back the pump input, and the nth Stokes outputs from the gain medium, are structured to suppress feedback of the (n+1) Stokes emission.

17. A Raman Laser device as claimed in claim 16 wherein n is odd.

18. A Raman Laser device as claimed in claim 16 where n is even.

19. A Raman laser system for lasing in substantially greater than about the 2 μm region, said system including:
a diamond core lasing medium;
a cascaded Stokes generation system surrounding said core and generating in said core, a first and second stokes output; said cascaded Stokes generation system including:
a first Stokes generation system generating a Stokes output below about 2 μm in the diamond core lasing medium;
a first Stokes pumping system pumping the diamond core lasing medium in conjunction with the first Stokes output to generate a second Stokes output in the range of greater than about 2 microns.

20. A Raman laser system as claimed in claim 19 wherein said cascaded Stokes generation system includes a first and second laser cavity including tuned reflective mirrors, tuned to the Stokes output.

21. A Raman laser system as claimed in claim 20 wherein the tuned reflective mirrors include an output mirror having reflectivity at the second Stokes output at about 0.3.

22. A Raman laser system as claimed in claim 20 wherein the tuned reflective mirrors include an output mirror having reflectivity at the first Stokes output at about 0.996.

23. A Raman laser system as claimed in claim 19 wherein said second stokes output is about 2.46 μm.

24. A Raman laser system as claimed in claim 19 wherein said first stokes output is about 1.85 μm.

25. A Raman laser system as claimed in claim 19 wherein said pumping system operates at about 1.49 μm.
